(19) United States
(12) Patent Application Publication
(10) Pub. No.: US 2026/0294745 A1
(43) Pub. Date: Oct. 1, 2026

(54) Bottle and Cup Hybrid Drinking Device

(71) Applicant: Karina Corcho, Jacksonville, AR (US)

(72) Inventor: Karina Corcho, Jacksonville, AR (US)

(21) Appl. No.: 19/455,913

(22) Filed: Jan. 22, 2026

Related U.S. Application Data
(60) Provisional application No. 63/777,035, filed on Mar. 25, 2025.

(51) Int. Cl. A61J 11/04; A61J 9/06; A61J 11/02

(52) U.S. Cl. CPC A61J 11/045; A61J 9/0623; A61J 9/0669; A61J 11/02

(57) ABSTRACT

A bottle and cup hybrid drinking device is provided. The device is comprised of a drinking cup having a cup body that comprises at least one grip texture and optionally a grip area made from high-friction materials to support manual handling by infants. The base of the cup body may be further comprised of a non-slip grip layer for surface stability, and wherein the body further comprises at least one handle that may also include a grip area and/or texture. The cup body comprises a threaded opening that receives a lid, which is removably attached using compatible threads. The lid comprises a spout with an internal flow path, wherein the spout is configured to receive a flexible nipple such that the nipple extends through the spout and allows fluid release via an opening of the nipple that is responsive to suction or pressure.

### CROSS-REFERENCE TO RELATED APPLICATION

The present application claims priority to, and the benefit of, U.S. Provisional Application No. 63/777,035, which was filed on Mar. 25, 2025, and is incorporated herein by reference in its entirety.

### FIELD OF THE INVENTION

The present invention relates generally to the field of drinking cups. More specifically, the present invention relates to a drink cup that serves as a transitional drinking vessel which enables infants to self-feed by combining the ergonomic structure of a sippy cup with the suction-responsive flow control of a bottle nipple. Accordingly, the present disclosure makes specific reference thereto. Nonetheless, it is to be appreciated that aspects of the present invention are also equally applicable to other like applications, devices, and methods of manufacture.

### BACKGROUND

Infants and toddlers often demonstrate a desire to independently hold and operate their own drinking vessels. However, developmental limitations can hinder their ability to effectively transition from traditional feeding bottles to open cups or standard sippy cups. Further, existing sippy cups generally employ free-flowing spouts that may be difficult for young children to regulate, leading to issues such as spillage, overconsumption, or frustration during use. As a result, parents frequently respond by purchasing a range of drinking vessels to accommodate various stages of development, often incurring unnecessary expense and contributing to inefficiencies in the transition process. The lack of a single adaptable solution that bridges the gap between bottle feeding and cup drinking presents ongoing challenges for caregivers. Furthermore, children benefit from familiarity and consistency in form and function when learning new skills, yet current market options often require abrupt changes in both. Existing products fail to offer a unified design that supports gradual developmental progression in both handling and liquid flow control. These challenges underscore a persistent and unaddressed need for a drinking vessel that effectively supports infants during this critical transitional period.

Therefore, there exists a long-felt need in the art for a bottle and cup hybrid drinking device that integrates the comfort and flow control of a bottle nipple with the ergonomic form of a sippy cup. There also exists a long-felt need in the art for a bottle and cup hybrid drinking device that allows infants to practice self-feeding with a vessel that supports both grip and stability. Moreover, there exists a long-felt need in the art for a bottle and cup hybrid drinking device that enables caregivers to reduce the number of transitional drinking products required during early childhood development.

The subject matter disclosed and claimed herein, in one embodiment thereof, comprises a bottle and cup hybrid drinking device. The device is comprised of a drinking cup having a cup body that comprises at least one grip texture and optionally a grip area made from high-friction materials to support manual handling by infants. The base of the cup body may be further comprised of a non-slip grip layer for surface stability, and wherein the body further comprises at least one handle that may also include a grip area and/or texture. The cup body comprises a threaded opening that receives a lid, which is removably attached using compatible threads. The lid comprises a spout with an internal flow path, wherein the spout is configured to receive a flexible nipple such that the nipple extends through the spout and allows fluid release via an opening of the nipple that is responsive to suction or pressure. The nipple is secured within the lid via a fastener system that aligns with a corresponding fastener on the spout interior.

In this manner, the bottle and cup hybrid drinking device of the present invention accomplishes all the foregoing objectives and provides a drink cup that integrates the suction-regulated flow mechanism of a traditional bottle with the ergonomic, graspable structure of a sippy cup. The inclusion of grip textures and high-friction materials further addresses the challenge of manual handling of the device by young children. The incorporation of a nipple within a spout configuration allows for gradual adjustment to cup usage while maintaining a familiar oral interface, easing the developmental transition. Collectively, the features of the device reduce the need for multiple transitional products and offer a practical, consolidated solution that supports the evolving motor and oral skills of infants.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bottle and cup hybrid drinking device that integrates the structural design of a sippy cup with the flow-regulation functionality of a bottle nipple. This hybrid configuration supports a gradual transition from bottle-feeding to cup drinking by accommodating varying developmental stages through controlled liquid flow while preserving a form factor that promotes ease of grasp and manipulation by infants.

The hybrid drinking vessel is comprised of a cup body. A grip texture may be applied to the external surface of the cup body to increase friction and tactile feedback. Additionally, a grip area comprised of high-friction, resilient material may be positioned on the cup body and may incorporate or overlay the grip texture. A bottom surface of the cup body may include a grip layer comprised of a non-slip material to prevent slippage on surfaces such as trays or tables. The cup body is further comprised of at least one handle that may include a grip texture and/or grip area positioned for ergonomic handling.

At least one transparent viewing window may be integrated into the cup body, allowing liquid visibility and measurement. The viewing window may include measurement markings in selectable units. An opening in the cup body provides access to an interior space and may include a threaded interface to receive a correspondingly threaded lid.

The lid is comprised of a rigid spout forming a flow path between a bottom opening and a top opening. A fastener located at the bottom opening of the spout engages a corresponding fastener on a base of a nipple, securing the nipple within the spout such that a tip of the nipple extends through the top opening of the spout. The nipple is comprised of at least one opening configured to release liquid in response to suction or biting on the tip.

Accordingly, the bottle and cup hybrid drinking device of the present invention is particularly advantageous as it provides a drink cup that integrates the suction-regulated flow mechanism of a traditional bottle with the ergonomic, graspable structure of a sippy cup. The inclusion of grip textures and high-friction materials further addresses the challenge of manual handling of the device by young children. The incorporation of a nipple within a spout configuration allows for gradual adjustment to cup usage while maintaining a familiar oral interface, easing the developmental transition. Collectively, the features of the device reduce the need for multiple transitional products and offer a practical, consolidated solution that supports the evolving motor and oral skills of infants.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bottle and cup hybrid drinking device of the present invention while assembled in accordance with the disclosed architecture;

FIG. 2 illustrates a perspective view of one potential embodiment of a bottle and cup hybrid drinking device of the present invention while unassembled in accordance with the disclosed architecture; and

FIG. 3 illustrates a perspective view of a lid and nipple of one potential embodiment of a bottle and cup hybrid drinking device of the present invention while assembled in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a bottle and cup hybrid drinking device that integrates the comfort and flow control of a bottle nipple with the ergonomic form of a sippy cup. There also exists a long-felt need in the art for a bottle and cup hybrid drinking device that allows infants to practice self-feeding with a vessel that supports both grip and stability. Moreover, there exists a long-felt need in the art for a bottle and cup hybrid drinking device that enables caregivers to reduce the number of transitional drinking products required during early childhood development.

The present invention, in one exemplary embodiment, is comprised of a bottle and cup hybrid drinking device. The device combines the structural design of a sippy cup with the flow-regulation functionality of a bottle nipple. This configuration facilitates a gradual transition from bottle-feeding to cup drinking by supporting different developmental stages through controlled liquid flow, while preserving a form that is easy for infants to grasp and manipulate.

The device is comprised of a cup body. A grip texture may be applied to the external surface of the cup body to enhance tactile feedback and increase friction. A grip area comprised of high-friction, resilient material may also be incorporated on the cup body and may either integrate with or overlay the grip texture. A bottom surface of the cup body may include a grip layer comprised of non-slip material to reduce slippage on contact surfaces such as trays or tables. The cup body may further include at least one handle, which may be configured with a grip texture and/or grip area to promote ergonomic handling.

At least one transparent viewing window may be integrated into the cup body to enable visual monitoring of liquid levels. The viewing window may include measurement markings in selectable units. An opening in the cup body provides access to an interior space and may include a threaded interface designed to engage with a correspondingly threaded lid.

The lid is comprised of a rigid spout forming a flow path between a bottom opening and a top opening. A fastener located at the bottom opening engages a corresponding fastener on a base of a nipple, securing the nipple within the spout so that a tip of the nipple projects through the top opening. The nipple is comprised of at least one opening that dispenses liquid in response to suction or biting on the tip.

As such, the device presents distinct advantages by integrating a suction-regulated flow system within an ergonomically structured sippy cup. The use of grip textures and high-friction materials further addresses handling challenges for young children. In addition, the spout-integrated nipple maintains a familiar oral interface, assisting in the transition to cup use. These combined features overcome the need for multiple transitional products and offer a unified solution that supports the development of motor and oral skills in infants.

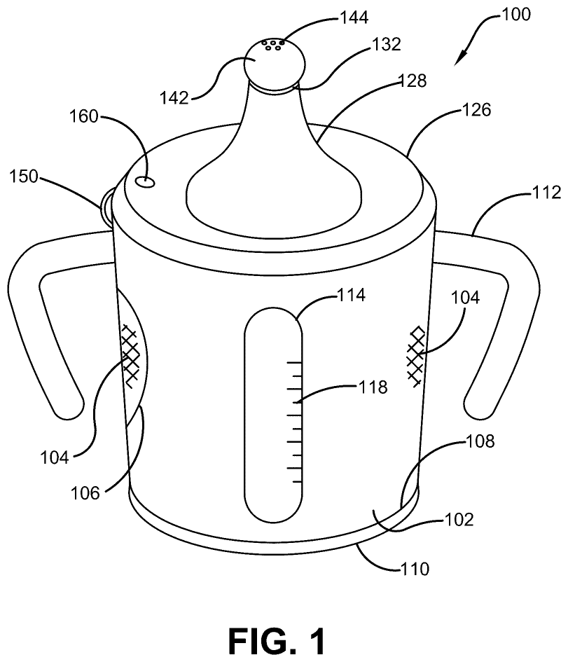

Referring initially to the drawings, FIG. 1 illustrates a perspective view of one potential embodiment of a bottle and cup hybrid drinking device 100 of the present invention while assembled in accordance with the disclosed architecture. The device 100 is hybrid drinking vessel that integrates the structural form of a traditional sippy cup with the flow-regulation functionality of a bottle nipple. This configuration may allow for the gradual transition of infants from bottle-feeding to cup drinking, accommodating varying developmental stages by modulating liquid flow while maintaining a familiar form factor that is easily grasped and manipulated by an infant.

The device 100 may be comprised of a cup body 102. The cup body 102 may be manufactured from food-grade materials suitable for hot and cold liquids. The cup body 102 may be of any shape such as but not limited to cylindrical, frustoconical, contoured, or hourglass configurations. In one embodiment, the cup body 102 is generally cylindrical to promote stability and balance, allowing the device 100 to be placed upright on a surface with minimal risk of tipping. In another embodiment, the cup body 102 may be inwardly tapered near the midsection to enhance ergonomic grip and reduce slippage.

The cup body 102 may be comprised of at least one grip texture 104. The grip texture 104 may be applied to the outer surface of the cup body 102 and may be in the form of but not limited to raised ridges, recessed grooves, dimples, bumps, crosshatch textures, or wave patterns. The grip texture 104 may enhance tactile feedback and friction between the infant's hand and the surface of the cup body 102 to minimize dropping during self-feeding. In yet another embodiment, the grip texture 104 may be continuous or segmented into multiple discrete zones around the circumference or height of the cup body 102.

The cup body 102 may additionally or alternatively be comprised of a grip area 106. The grip area 106 may be comprised of a high-friction, resilient material such as but not limited to silicone, rubber, thermoplastic elastomer (TPE), or over-molded elastomeric compounds. In one embodiment, the grip area 106 may be shaped as a band, patch, or panel positioned where an infant's fingers naturally make contact with the body 102. In another embodiment, the grip texture 104 may be integrated within or overlaid upon the grip area 106. A bottom surface 108 of the cup body 102 may be comprised of a textured or non-textured grip layer 110. The grip layer 110 may be made from a non-slip material such as but not limited to silicone, rubber, TPE, or polyurethane. The grip layer 110 may reduce the likelihood of unintentional movement or slippage of the device 100 on surfaces such as plastic trays, wooden tables, or countertops.

The cup body 102 may be comprised of at least one handle 112. The handle 112 may be of any configuration such as but not limited to loop-style, side-mounted, dual-handled, arched, curved, or ergonomically angled handles. In one embodiment, the handle 112 may be integrally molded with the cup body 102. In another embodiment, the handle 112 may be detachable from the body 102. The handle 112 may include the grip texture 104 and/or grip area 106 to enhance secure handling. In one embodiment, the grip area 106 may be positioned on the outer curve of the handle 112 to align with finger placement.

The cup body 102 may be comprised of at least one transparent viewing window 114. The viewing window 114 may be comprised of a transparent or semi-transparent material. In one embodiment, the viewing window 114 may occupy a vertical strip along the sidewall of the cup body 102. In another embodiment, multiple viewing windows 114 may be arranged around the perimeter to enable visibility from multiple angles. The viewing window 114 may be further comprised of measurement markings 118. The measurement markings 118 may be indicated in units such as but not limited to milliliters, ounces, or cubic centimeters.

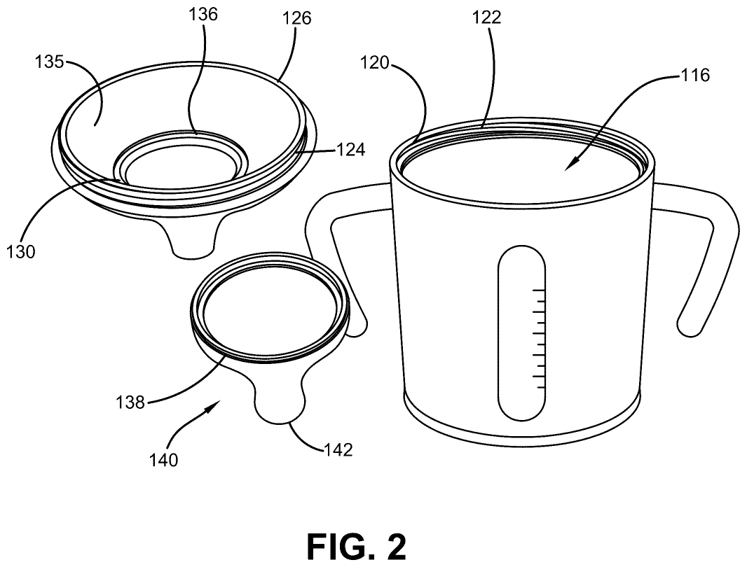

The cup body 102 may be comprised of an opening 120 that provides access to the interior space 116, as seen in FIG. 2. The opening 120 may be comprised of a thread 122, which may be configured to engage a corresponding thread 124 positioned on a lid 126. The threads 122,124 may be helical, bayonet-style, or quarter-turn to facilitate ease of engagement and sealing.

The lid 126 may also be comprised of a rigid spout 128. The spout 128 may be formed as an upwardly projecting tube or nozzle with an internal flow path connecting a bottom opening 130 and a top opening 132. The bottom opening 130 may be located on a bottom surface 134 of the lid 126. The top opening 132 may be located at the distal end of the spout 128. The spout 128 may be angled, tapered, or flared to conform to oral comfort and ergonomic alignment with an infant's mouth.

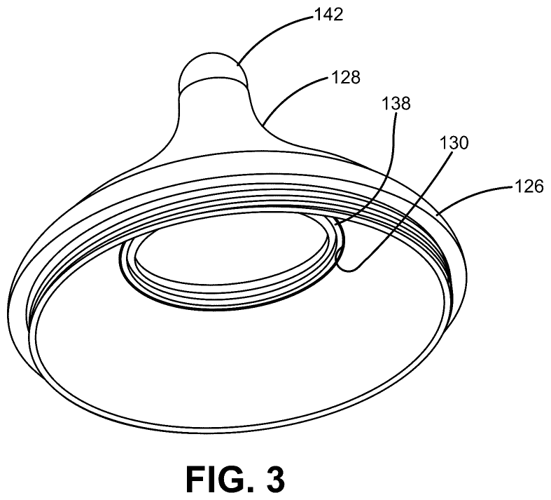

The bottom opening 130 of the spout 128 may be comprised of a fastener 136, as seen in FIG. 2. The fastener 136 may be configured as a groove, channel, flange, bayonet-lock, snap-fit ridge, or retention ring. The fastener 136 may engage with a corresponding fastener 136 located on a base 138 of a nipple 140 such that the nipple 140 may be inserted into the spout 128 from the underside of the lid 126 such that a tip 142 of the nipple 140 extends outwardly through the top opening 132 of the spout 128, as seen in FIG. 3 and FIG. 1.

The nipple 140 may be comprised of flexible, food-safe materials such as but not limited to silicone, latex, or thermoplastic elastomer. The nipple 140 may be comprised of at least one opening 144 located at the tip 142. The opening 144 may be configured as a slit, pinhole, star-cut, or valve-controlled aperture that allows liquid to be released in response to suction or biting pressure on the tip 142.

In one embodiment, the lid 126 is attached to the cup body 102 via a tether 150, as seen in FIG. 1. The tether 150 may be comprised of a flexible material. The tether 150 may prevent the lid 126 from being separated or lost during use or cleaning. In one embodiment, the device 100 is also further comprised of a vent 160 positioned in the lid 126 and/or in the cup body 102. The vent 160 may function as an anti-colic feature by allowing air to enter the interior space 116 of the cup body 102 as liquid is drawn through the nipple 140. The vent 160 may reduce negative pressure and minimize the ingestion of air bubbles by the infant. The vent 160 may be in the form of a one-way valve, slit membrane, or micro-perforated barrier that allows air inflow while preventing liquid leakage.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bottle and cup hybrid drinking device” and “device” are interchangeable and refer to the bottle and cup hybrid drinking device 100 of the present invention.

Notwithstanding the foregoing, the bottle and cup hybrid drinking device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bottle and cup hybrid drinking device 100 as shown in the FIGS. are for illustrative purposes only, and that many other sizes and shapes of the bottle and cup hybrid drinking device 100 are well within the scope of the present disclosure. Although the dimensions of the bottle and cup hybrid drinking device 100 are important design parameters for user convenience, the bottle and cup hybrid drinking device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bottle and cup hybrid drinking device comprising:
a cup body comprised of a first thread;
a lid comprised of a second thread configured to attach to the first thread;
a spout formed on the lid, the spout comprising a bottom opening and a top opening; and
a nipple position within the spout, wherein a tip of the nipple extends through the top opening of the spout.

2. The bottle and cup hybrid drinking device of claim 1, wherein the nipple is comprised of a flexible material.

3. The bottle and cup hybrid drinking device of claim 2, wherein the tip is comprised of an opening.

4. The bottle and cup hybrid drinking device of claim 1 further comprised of a vent.

5. The bottle and cup hybrid drinking device of claim 4, wherein the vent is comprised of a one-way valve.

6. The bottle and cup hybrid drinking device of claim 1, wherein the cup body is comprised of a first texture.

7. The bottle and cup hybrid drinking device of claim 1, wherein the cup body is comprised of a grip area comprised of a silicone, a rubber, or a thermoplastic elastomer.

8. The bottle and cup hybrid drinking device of claim 7, wherein the grip area is comprised of a second texture.

9. A bottle and cup hybrid drinking device comprising:
a cup body comprised of a first thread and a handle;
a lid comprised of a second thread configured to attach to the first thread;
a spout formed on the lid, the spout comprising a bottom opening and a top opening; and
a nipple position within the spout, wherein a tip of the nipple extends through the top opening of the spout.

10. The bottle and cup hybrid drinking device of claim 9, wherein the cup body or the handle is comprised of a texture.

11. The bottle and cup hybrid drinking device of claim 9, wherein the cup body or the handle is comprised of a grip area comprised of a silicone, a rubber, or a thermoplastic elastomer.

12. The bottle and cup hybrid drinking device of claim 9, wherein the bottom opening is comprised of a fastener.

13. The bottle and cup hybrid drinking device of claim 12, wherein the fastener is comprised of a groove, a channel, a flange, a bayonet-lock, a snap-fit ridge, or a retention ring.

14. The bottle and cup hybrid drinking device of claim 13, wherein a base of the nipple engages the fastener.

15. The bottle and cup hybrid drinking device of claim 9, wherein the tip is comprised of an opening comprised of a slit, a pinhole, a star-cut, or a valve-controlled aperture.

16. A bottle and cup hybrid drinking device comprising:
a cup body comprised of a first thread, a transparent viewing window, and a handle;
a lid comprised of a second thread configured to attach to the first thread;
a spout formed on the lid, the spout comprising a bottom opening and a top opening; and
a nipple position within the spout, wherein a tip of the nipple extends through the top opening of the spout.

17. The bottle and cup hybrid drinking device of claim 16, wherein the viewing window is comprised of a measurement marking.

18. The bottle and cup hybrid drinking device of claim 16, wherein the cup body or the lid is comprised of a vent.

19. The bottle and cup hybrid drinking device of claim 18, wherein the vent is comprised of a one-way valve, a slit membrane, or a micro-perforated barrier.

20. The bottle and cup hybrid drinking device of claim 16, wherein the transparent viewing window is in the form of a vertical strip.
